(19) United States
(12) Patent Application Publication
(10) Pub. No.: US 2015/0114739 A1
(43) Pub. Date: Apr. 30, 2015

(54) Hydraulic Hybrid Vehicle

(71) Applicant: Curtis Arnold Newman, Los Angeles, CA (US)

(72) Inventor: Curtis Arnold Newman, Los Angeles, CA (US)

(21) Appl. No.: 14/068,438

(22) Filed: Oct. 31, 2013

(51) Int. Cl. B60K 6/00; B60L 11/18

(52) U.S. Cl. CPC B60K 6/00; B60L 11/18
USPC 180/165; 180/65.245

(57) ABSTRACT

The presently described apparatus and method describes the construction, use and operation of a hydraulic hybrid vehicle including the components and the manner by which the components are integrated into a standard electric powered vehicle. The vehicle may be powered by an electric motor, by a hydraulic motor, or by both acting together.

### BACKGROUND

The industrial field of this disclosure relates to vehicles which are propelled by other than an internal combustion or external combustion energy source. This disclosure is particularly directed to an electrically driven vehicle, an electrical-hydraulic driven vehicle, and a hydraulically driven vehicle, and to the conversion of electrical vehicles to add hydraulic drive or staging power.

A two-stage vehicle is a vehicle that has been built by two separate manufacturers. The result is a complete roadworthy vehicle. In this process, vehicles may be converted by a manufacturer, as was done by Ford Motor Company to create the Ford Ranger EV. Alternatively, in a process known as “third-party power-train-modification,” an independent converter purchases a new and then performs a conversion, to produce a two-stage vehicle. In some countries, the user can choose to buy a converted vehicle of any model in the automaker dealerships only paying the cost of the batteries and motor, with no installation costs. This is typically called pre-conversion or previous conversion.

Electric cars are a variety of electric vehicle (EV); the term “electric vehicle” refers to any vehicle that uses electric motors for propulsion, while “electric car” generally refers to road-going automobiles powered by electricity. While an electric car's power source is not explicitly an on-board battery, electric cars with motors powered by other energy sources are generally referred to by a different name: an electric car powered by sunlight is a solar car, and an electric car powered by a gasoline generator is a form of hybrid car. Thus, an electric car that derives its power from an on-board battery pack is a form of battery electric vehicle (BEV). Most often, the term “electric car” is used to refer to battery electric vehicles.

In the 1990s, a team of engineers working at EPA's National Vehicle and Fuel Emissions

Laboratory succeeded in developing a revolutionary type of petro-hydraulic hybrid powertrain that would propel a typical American sedan car. The test car achieved over 80 mpg on combined EPA city/highway driving cycles. Acceleration was 0-60 mph in 8 seconds, using a 1.9 liter diesel engine. The EPA estimated that produced in high volumes the hydraulic components would add only $700 to the base cost of the vehicle. While the petro-hydraulic system has faster and more efficient charge/discharge cycling and is cheaper than petro-electric hybrids, the accumulator size dictates total energy storage capacity and may require more space than a battery set. Research is underway in large corporations and small companies. Focus has now switched to smaller vehicles. The system components were expensive which precluded installation in smaller trucks and cars. A drawback was that the power driving motors were not efficient enough at part load. A British company has made a breakthrough by introducing an electronically controlled hydraulic motor/pump, that is highly efficient at all speed ranges and loads making small applications of petro-hydraulic hybrids feasible. The company converted a BMW car as a test bed to prove viability. The BMW 530i, gave double the mpg in city driving compared to the standard car. Petro-hydraulic hybrids using well-sized accumulators entail downsizing an engine to average power usage, not peak power usage. Peak power is provided by the energy stored in the accumulator. A smaller more efficient constant speed engine reduces weight and liberates space for a larger accumulator. Current vehicle bodies are designed around the mechanicals of existing engine/transmission setups. It is restrictive and far from ideal to install petro-hydraulic mechanicals into existing bodies not designed for hydraulic setups. One research project's goal is to create a blank paper design new car, to maximize the packaging of petro-hydraulic hybrid components in the vehicle. All bulky hydraulic components are integrated into the chassis of the car. One design has claimed to return 130 mpg in tests by using a large hydraulic accumulator which is also the structural chassis of the car. The small hydraulic driving motors are incorporated within the wheel hubs driving the wheels and reversing to claw-back kinetic braking energy. The hub motors eliminate the need for friction brakes, mechanical transmissions, drive shafts and U joints, reducing costs and weight. Hydrostatic drive with no friction brakes are used in industrial vehicles. The aim is 170 mpg in average driving conditions. Energy created by shock absorbers and kinetic braking energy that normally would be wasted assists in charging the accumulator. A small fossil fuelled piston engine sized for average power use charges the accumulator. The accumulator is sized for running the car for 15 minutes when fully charged. The aim is a fully charged accumulator with an energy storage potential of 670 HP, which will produce a 0-60 mph acceleration speed of under 5 seconds using four wheel drive. In January 2011 industry giant Chrysler announced a partnership with the U.S. Environmental Protection Agency (EPA) to design and develop an experimental petro-hydraulic hybrid powertrain suitable for use in large passenger cars. In 2012 an existing production minvan will be adapted to the new hydraulic powertrain. The present disclosure provides an apparatus that overcomes the problems found in the prior art and extends the technology into a more realistic and practical regime.

### BRIEF DESCRIPTION OF DRAWINGS

FIG. 1 is an example block diagram of an embodiment of the presently described apparatus;

FIG. 2 is a logic diagram describing operation thereof.

Like reference symbols in the drawing figures indicate like elements.

### DETAILED DESCRIPTION

The presently described apparatus and its method of use refer to an electric automobile truck, or bus, referred to herein by the term “vehicle.” However, practically, the vehicle may not only be wheel-driven vehicles, but also a may be a water borne vehicle such as a power boat or other types of vehicles. In the present description we refer to a specific embodiment which is a particular automobile that represents a typical consumer operated automobile and its best use is in the mass vehicle marketplace which vehicles are used for transportation, commuting, shopping and other daily activities that require personal transportation.

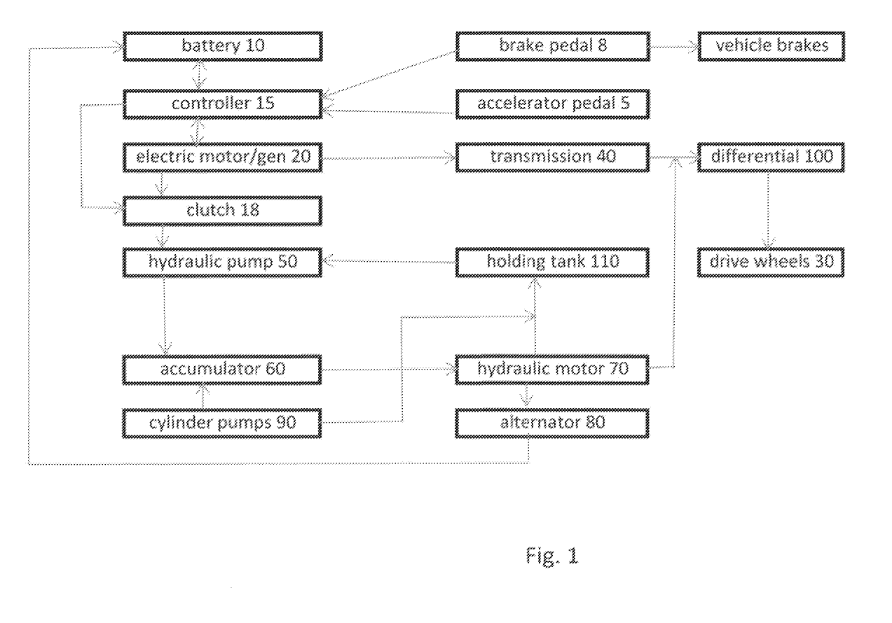

The vehicle described herein comprises a standard commercially available and typical production electric automobile referred to herein as the “purchased unit,” as for instance a model BY-03 manufactured by Shandong Baoya New Energy Vehicle Co. Ltd. of China. Included in the purchased unit are (see FIGS. 1, 2, and 3): battery 10, electric motor/gen 20, drive wheels 30, transmission 40, differential 100, and all other components, assemblies, subassemblies, typically found in a fully operational consumer vehicle, i.e., seats, steering wheel, gauges, lights, operator's panel, etc. The purchased unit is then modified by installation and integration of “selected components” as described in detail below and such modification of and integration into the purchased unit is within the skill of typical automotive mechanics without undue experimentation. However, the selected components and their integration scheme, as described herein, is considered to be novel and would not be obvious to those of skill in the automotive trades, skills, and know-how. The composite prior art cannot be considered to teach the present apparatus or to render it obvious to those of skill in the art.

The major selected components may include:
Hydraulic pump 50, an Eaton Manufacturing Co., model S26, rated as 6.6 gpm, at 3000 psi.
Accumulator 60, a nitrogen bladder type supplied by Eaton as part number A2 30 and rated at 3000 psi.
Hydraulic motor 70, an H series by Eaton rated at 3000 psi and 1,000 rpm.
Alternator 80 manufactured by Fast Max Alternators and rated at 98 vdc and 12 KW output.
Hydraulic cylinder pumps 90, by Milwaukee Cylinder, LH series.
Holding tank 110, by Eaton specified as Low Pressure Holding and Cooling Tank.
Controller 15 manufactured by Siemens Electric Vehicle Division providing inversion pulse frequency alternating current output and provides logic signals for control.

Various other components well known in the art in accordance with the above major components, are included, such as sprockets, pulleys, clutch, and related interconnecting belts by Fast Max, standard electrical cables and conduits, high pressure fluid conduits, a 4:1 step-up gear set by Fast Max and miscellaneous hardware items used for installation into the vehicle as would be known to those of skill in the mechanical, hydraulic, and electrical trades without undue experimentation.

Now referring to a first embodiment of the apparatus, shown in FIG. 1, the vehicle may use, for instance, a direct current (vdc) lithium-ion electrical battery 10, or other type of battery, which delivers a pulsed current to 30 horsepower (hp) electrical motor/gen 20 through controller 15. With ignition on and transmission 40 in drive, accelerator pedal 5 sends a control voltage to controller 15 which adjusts its output pulse frequency to provide a driver selected drive voltage to electric motor/gen 20 so as to accelerate or maintain vehicle velocity as desired through transmission 40, differential 100, and drive wheels 30. When the driver releases accelerator pedal 5, controller 15 sets drive voltage to zero. If electric motor 20 continues to rotate, driven by drive wheels 30 through differential 100 and transmission 40 due to vehicle momentum or if on a downgrade by vehicle momentum and gravitational force, electric motor/gen 20 operates as an electric generator and controller 15 sends a signal which closes clutch 18 thereby enabling electric motor/gen 20 to rotate hydraulic pump 50 via a mechanical linkage of any type known to those of skill in the art. Pump 50 delivers hydraulic pressure to accumulator 60 which operates hydraulic motor 70 and alternator 80 to send a charging current to battery 10.

When drive voltage is zero and clutch 18 is engaged, a braking force from hydraulic pump 50 is applied to drive wheels 30 through electric motor/gen 20 transmission 40 and differential 100. Brake pedal 8 may be applied by the vehicle operator as well to slow the vehicle more quickly or bring it to a stop.

Hydraulic cylinder pumps 90 are mounted between the vehicle's carriage and its suspension system so that while the vehicle is being driven, as the vehicle's wheels move vertically due to terrain roughness, pumps 90 produce hydraulic pressure in accumulator 60. Hydraulic fluid is returned to hydraulic pump 50 from the hydraulic motor 70 and cylinder pumps 90 via holding tank 110. In this hydraulic system overpressure relief valves and check valves are employed to eliminate back pressure and cavitation in system components and lines.

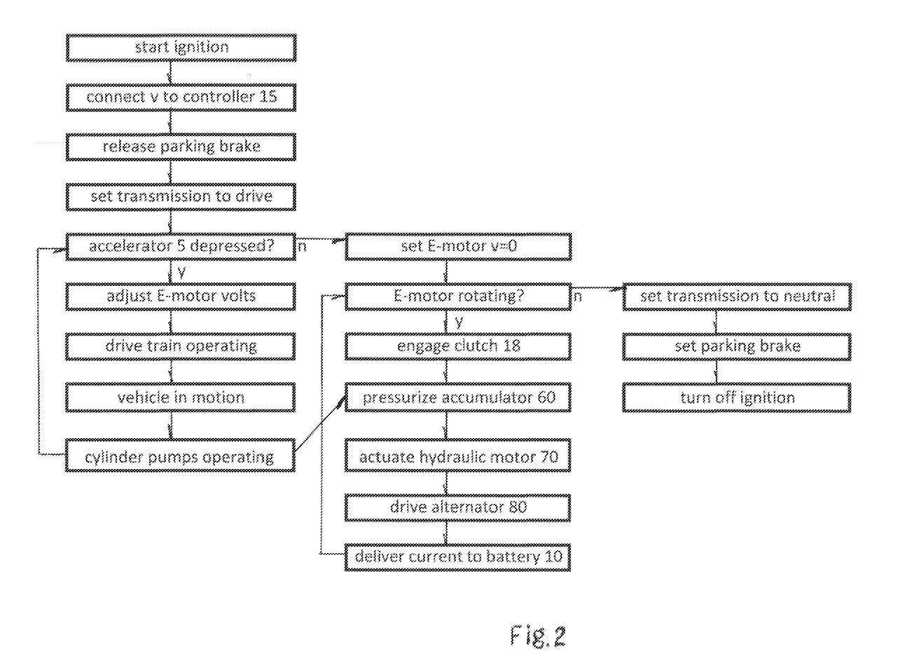

In an alternate embodiment, as shown in FIG. 2, hydraulic motor 70 is engaged with transmission 40 and may be used to provide driving force to drive wheels 30 alone or in addition to electric motor/gen 20. This additional power may be useful when greater acceleration or hauling power is required. The operation of this dual drive is controlled by signals from controller 15 as enabled by actuators accessible to the driver from his control panel. In an alternate method of operating the apparatus, transmission 40 can be disengaged from electric motor/gen 20 allowing hydraulic motor 70 to be the primary vehicle drive and allowing the electric motor/gen 20 to only operate pump 50.

The controller 15 delivers a proportional voltage to electric motor/gen 20 so as to accelerate or maintain vehicle velocity. Electric motor/gen 20 may be operated according to a standard digital pulse voltage signal with pulse rate controlling the average voltage delivered to electric motor/gen 20. The accelerator pedal may operate through a potentiometer circuit whose signal is delivered to controller 15. Storage battery 10 may be made up of a plurality of low voltage batteries cells arrange in electrical series connection to achieve a higher drive voltage such as 144 vdc. The operation of electric motor operation and control through pulse voltage inputs is well known in the field of the present apparatus. Electric motor/gen 20 is an alternating current device operable by a pulse voltage whose frequency determines the average applied voltage received. The controller 15 inverts dc battery voltage to a pulsed ac voltage, and adjusts the ac voltage pulse frequency based on the drive current demanded by the driver's accelerator pedal 5. It also provides coasting and regenerative braking using electric motor/gen 20 as an electric generator for converting the vehicle's kinetic energy to power which is delivered to battery 10, as previously described. Controller 15 protects electric motor/gen 20 from overheating using thermo-couple sensors attached to electric motor/gen 20 and protecting against current overloads by placement of ammeter sensors in the several circuits which protects battery 20 from under voltage during acceleration and from over voltage during regeneration. The controller 15 also provides 12 vdc to operate vehicle accessories, displays operating parameter displays, etc.

The controller has a microprocessor computer and solid state memory holding a logic program which controls operation of the vehicle. Programming enables making timing adjustments relevant to internal signals, interfacing with closed loop hydraulic systems sensors that monitor hydraulic fluid flow rates, temperature and pressure, clutch state, and other necessary features.

Made by Siemens Corporation, controller 15 is 94% energy efficient and is specifically developed for use in electric vehicles. It is rated at 280 amps at 380 vdc which enables it to handle up to 100 kW of power.

The presently described apparatus converts two kinetic energy inputs to electrical energy stored in battery 20. First, kinetic energy is derived from rotation of the output shaft of electric motor/gen 20 as driven by transmission 40 when the input voltage to electric motor/gen 20 from controller 15 is zero (accelerator pedal 8 not depressed). Electric motor/gen 20 delivers power to battery 10 through the hydraulic system at this time as previously described. Second, kinetic energy is harvested from cylinder pumps 90 which function once the vehicle is in motion over a road. Vehicle operation creates a reciprocating vertical motion of these pumps 90 whose average frequency at a vehicle speed of 25 mph of between one and three cycles per second (cps) with a total linear travel of between two and six centimeters per cycle. Cylinder pumps 90 operate at a pressure of 2,000 psi and a flow rate of about 5 gallons per minute (gpm) under a load of about 570 pounds on each cylinder. Two or more cylinder pumps 90 may be used in the present application. Hydraulic pressure is delivered to accumulator 60 which drives hydraulic motor 70, and alternator 80 to deliver electrical current to battery 10 as previously described. A drive arrangement comprising pulleys and belts or gears enable engagement and disengagement of clutch 18 between electric motor/gen 20 and hydraulic pump 50. In the first embodiment, hydraulic pump 50 is powered only when electric motor/gen 20 has a zero voltage input from controller 15. In test vehicles on a level road, electric motor/gen 20 used 7.5 KW continuously to produce a steady vehicle velocity of 40 mph. At the same time cylinder pumps 90 produced about 1.7 KW continuous which is recovered by battery 10, as 1.7 KW-h per hour. The net result is that the cylinder pumps 90 carry about 23% of the energy required for vehicle operation. This results in a 23% extension of vehicle range.

Embodiments of the subject apparatus and method have been described herein. Nevertheless, it will be understood that modifications may be made without departing from the spirit and understanding of this disclosure. Accordingly, other embodiments and approaches are within the scope of the following claims.

What is claimed is:

1. A vehicle comprising:
an electric motor-generator powered by an electric battery through a controller for driving the vehicle;
the controller converting a dc battery voltage of the electric battery to a pulsed alternating current output delivered to the electric motor-generator;
the current output controlled by a manual accelerator of the vehicle;
a hydraulic pump engaged with the electric motor-generator when the manual accelerator is not operated;
a hydraulic motor operated by the hydraulic pump, the hydraulic motor operating an alternator, the alternator engaged with the battery for delivering a charging current to the battery.

2. The vehicle of claim 1 wherein the hydraulic pump charges an accumulator wherein hydraulic pressure in the accumulator operates the hydraulic motor.

3. The vehicle of claim 2 further comprising cylinder pumps interconnected with and operated by vehicle wheels during vehicle movement over a road.

4. The vehicle of claim 3 wherein each one of said vehicle wheels is associated with at least one said cylinder pump.

5. The vehicle of claim 1 wherein the hydraulic motor engages the vehicle drive wheels.

6. A vehicle comprising:
an electric motor-generator powered by an electric battery through a controller for driving the vehicle;
the controller converting a dc battery voltage of the electric battery to a pulsed alternating current output delivered to the electric motor-generator;
the current output controlled by a manual accelerator of the vehicle;
a hydraulic pump engaged with the electric motor-generator when the manual accelerator is not operated;
a hydraulic motor operated by the hydraulic pump, the hydraulic motor operating an alternator, the alternator engaged with the battery for delivering a charging current to the battery; and
the hydraulic motor engaged for driving the vehicle.

7. The vehicle of claim 6 wherein the hydraulic pump charges an accumulator wherein hydraulic pressure in the accumulator operates the hydraulic motor.

8. The vehicle of claim 7 further comprising cylinder pumps interconnected with and operated by vehicle wheels during vehicle movement over a road.

9. The vehicle of claim 8 wherein each one of said vehicle wheels is associated with at least one said cylinder pump.

10. The vehicle of claim 6 wherein the hydraulic motor engages the vehicle wheels for driving the vehicle.

11. A method of operating a vehicle comprising:
checking if accelerator is depressed adjust electric motor voltage according to accelerator position;
transfering hydraulic pressure from cylinder pumps to an accumulator;
checking if accelerator is depressed;
if accelerator is not depressed seting electric motor voltage to zero;
if electric motor is rotating engaging electric motor with hydraulic pump;
pressurizing accumulator;
actuating hydraulic motor to drive an alternator delivering alternator output current to vehicle battery;
checking if electric motor is rotating;
if electric motor is not rotating seting transmission to neutral;

12. The method of operating a vehicle of claim 11 further comprising engaging the hydraulic motor to drive the vehicle.
